(19) United States
(12) Patent Application Publication
(10) Pub. No.: US 2025/0328352 A1
(43) Pub. Date: Oct. 23, 2025

(54) COMPUTER-READABLE RECORDING MEDIUM HAVING STORED THEREIN RELAY PROGRAM, RELAY METHOD, AND INFORMATION PROCESSING APPARATUS

(71) Applicant: Fujitsu Limited, Kawasaki-shi (JP)

(72) Inventor: Shinya KUWAMURA, Kawasaki (JP)

(73) Assignee: Fujitsu Limited, Kawasaki-shi (JP)

(21) Appl. No.: 19/257,641

(22) Filed: Jul. 2, 2025

Related U.S. Application Data
(63) Continuation of application No. PCT/JP2023/045650, filed on Dec. 20, 2023.

(30) Foreign Application Priority Data
Feb. 2, 2023 (JP) 2023-014694

(51) Int. Cl. G06F 9/4401

(52) U.S. Cl. CPC G06F 9/4403

(57) ABSTRACT

A computer-readable recording medium having stored therein a program causing a computer to execute a relay process including obtaining, from an application, an initialization request for initializing a first resource used by the application, transmitting, based on the initialization request, to a management system that manages hardware resources, an allocation request for allocating the first resource to a first computer on which the application is executed, causing the application to start pre-processing performed before a calculation process to be executed by the first resource, transmitting the initialization request to the first resource in response to receiving an allocation completion response indicating that the first resource is allocated to the first computer from the management system, and transmitting, in response to obtaining the calculation request of the calculation process from the application after the pre-processing is completed, the calculation request to the first resource.

### CROSS-REFERENCE TO RELATED APPLICATION

This application is a continuation application of International Application PCT/JP2023/045650 filed on Dec. 20, 2023 and designated the U.S., which International Application is based upon and claims the benefit of priority of the prior Japanese Patent Application No. 2023-014694 filed on Feb. 2, 2023, the entire contents of which are incorporated herein by reference.

### FIELD

The present embodiment relates to a computer-readable recording medium having stored therein a relay program, a relay method, and an information processing apparatus.

### BACKGROUND

A composable infrastructure (CI or Composable Disaggregated Infrastructure (CDI)) is known as a technology for improving utilization efficiency of hardware resources, providing a physical server having a flexible configuration, and the like.

The composable infrastructure is realized by an architecture that connects an information processing apparatus such as a server and a resource pool including a plurality of hardware resources separated from the server by a high-speed interconnect. Examples of the hardware resources include various resources such as a processing device (processing unit) such as a graphics processing unit (GPU) and an accelerator, and a storing device such as a memory and a storage.

The composable infrastructure allows a resource (for example, GPU) to be added to a server once the resource (GPU) is needed in an application running on the server. Thus, in the composable infrastructure, it is possible to dynamically add resources to the server.

The composable infrastructure includes a management system. The management system manages the allocation of resources to the server. For example, the management system controls the switch that switches the connection of the interconnect in response to receiving an allocation request of the resource, and causes the server to detect (recognize) the resource, thereby realizing the allocation of the resource to the server.

Hereinafter, the following processes (1) to (5) will be described as an example of an operation mode of the composable infrastructure.

(1) In a case where the application requires a GPU, for example, in a case where an artificial intelligence (AI) task such as object detection on an image is performed, the application issues a resource allocation request to the management system and suspends operation (for example, an AI task).

(2) The management system allocates a GPU to the server in response to receiving the resource allocation request, and issues a completion response of the resource allocation to the server (application).

(3) In response to receiving the completion response, the application detects the allocated GPU and issues an initialization request for initializing the GPU to the GPU (resource pool).

(4) In response to receiving an initialization completion response to the initialization request, the application resumes the suspended operation (for example, AI task), issues a calculation request to the GPU, and receives a calculation result from the GPU.

(5) When the application completes using (calculating) the GPU, the management system releases the allocation of the GPU to the server.

For example, a related art is disclosed in Japanese Laid-Open Patent Publication No. 2012-32873.

### SUMMARY

According to an aspect of the embodiments, a computer-readable recording medium having stored therein a relay program that causes a computer to execute a relay process including: obtaining, from an application, an initialization request for initializing a first resource being a hardware resource used by the application; transmitting, based on the initialization request, to a management system that manages a plurality of the hardware resources, an allocation request for allocating the first resource to a first computer on which the application is executed; causing the application to start pre-processing being performed before a calculation process to be executed by the first resource; transmitting the initialization request to the first resource in response to receiving an allocation completion response to the allocation request from the management system, the allocation completion response indicating that the first resource is allocated to the first computer from among the plurality of hardware resources; and transmitting, in response to obtaining the calculation request of the calculation process from the application after the pre-processing is completed, the calculation request to the first resource.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a hardware configuration of a system according to an embodiment;

FIG. 2 is a block diagram illustrating an example of a hardware configuration of a computer as an example of a server according to the embodiment;

FIG. 3 is a block diagram illustrating an example of a software configuration of the server illustrated in FIG. 1;

FIG. 4 is a diagram for explaining an implementation example of a relay module;

FIG. 5 is a diagram for explaining an implementation example of the relay module;

FIG. 6 is a sequence diagram for explaining an operation example of the system according to the embodiment;

FIG. 7 is a flowchart illustrating an operation example of an initialization control unit of the relay module according to the embodiment;

FIG. 8 is a flowchart illustrating an operation example of an allocation determining unit of the relay module according to the embodiment;

FIG. 9 is a flowchart illustrating an operation example of a calculation control unit of the relay module according to the embodiment;

FIG. 10 is a block diagram illustrating an example of a software configuration of a server according to a modification of the embodiment;

FIG. 11 is a diagram for explaining an implementation example of an initialization control unit according to the modification of the embodiment; and

FIG. 12 is a sequence diagram for explaining an operation example of a system according to the modification of the embodiment.

### DESCRIPTION OF EMBODIMENTS

In an operation mode in which a resource such as a GPU is allocated (added) from a resource pool to a server during execution of an application, execution of the application is suspended until the allocation of the resource to the server is completed.

For example, since hardware configuration change including resource allocation may take about several ten seconds, execution of the application is suspended for about several ten seconds. In addition, as the number of resources to be added increases, the suspending time further increases.

As described above, in the above-described operation style of the composable infrastructure, the execution time from the start to the end of the execution of the application may be prolonged.

Hereinafter, embodiments of the present disclosure will be described with reference to the drawings. However, the embodiments described below are merely examples, and there is no intention to exclude the application of various modifications and techniques that are not explicitly described below. For example, the present embodiment can be variously modified and implemented without departing from the gist thereof. Note that, in the drawings used in the following description, portions denoted by the same reference numerals represent the same or similar portions unless otherwise specified.

### (A) Example of Hardware Configuration

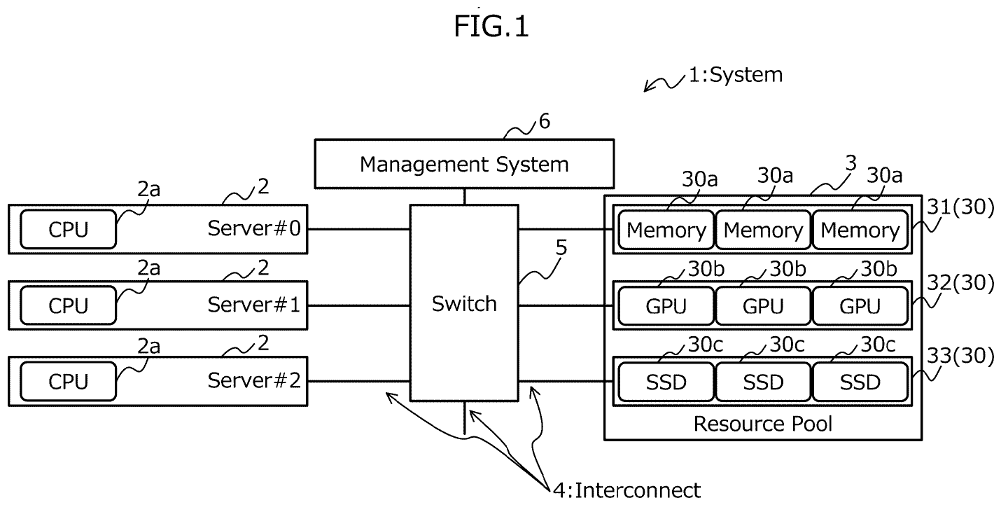

FIG. 1 is a block diagram illustrating an example of a hardware configuration of a system 1 according to an embodiment. As illustrated in FIG. 1, the system 1 may include a plurality of (three in FIG. 1) servers 2 (denoted as servers #0 to #2 in FIG. 1), a resource pool 3, an interconnect 4, a switch 5, and a management system 6, for example.

The system 1 is an example of an information processing system that allocates resources in the resource pool 3 to the server 2 and causes the server 2 to execute a process using the resources.

Each of the plurality of servers 2 is an example of an information processing apparatus (first information processing apparatus) or a computer. The server 2 may include at least a central processing unit (CPU) 2a as hardware resources. The CPU 2a is an example of a processor, and executes various software including an application.

The server 2 may be a general-purpose computer or a computer in which at least a part of the hardware resources constituting the computer is omitted on the premise that the resource pool 3 is used.

In the embodiment, the server 2 will be described as, for example, a general-purpose computer having a minimum hardware resource in which the server 2 can independently operate, in addition to the CPU 2a. Hereinafter, the hardware resource may be simply referred to as hardware (HW) or a resource.

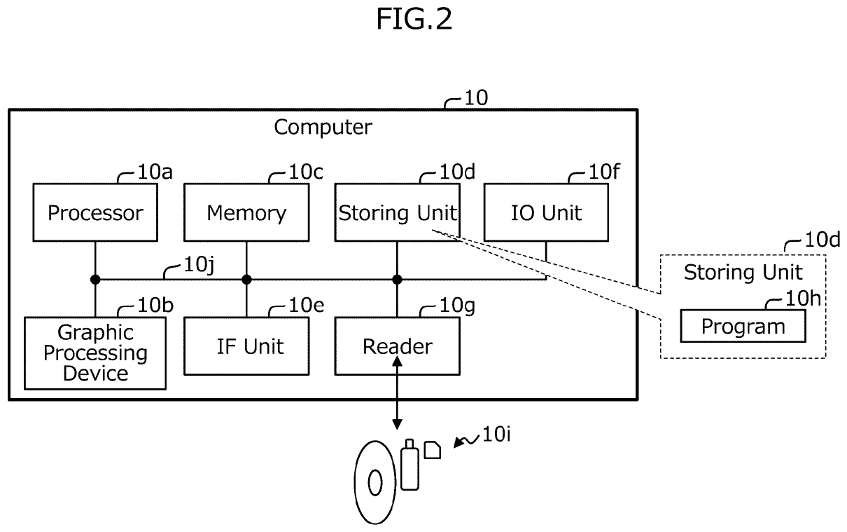

FIG. 2 is a block diagram illustrating an example of a hardware configuration of a computer 10 as an example of the server 2 according to the embodiment. As illustrated in FIG. 2, the computer 10 may include a processor 10a, a graphic processing device 10b, a memory 10c, a storing unit 10d, an interface (IF) unit 10e, an input/output (IO) unit 10f, and a reader 10g as a hardware configuration, for example.

The processor 10a is an example of an arithmetic processing device that performs various controls and calculations. The processor 10a may be communicably connected to each block in the computer 10 via a bus 10j. Note that the processor 10a may be a multiprocessor including a plurality of processors, may be a multi-core processor including a plurality of processor cores, or may have a configuration including a plurality of multi-core processors.

Examples of the processor 10a include the CPU 2a illustrated in FIG. 1. Further, another example of the processor 10a may be an integrated circuit (IC) such as an MPU, an APU, a DSP, an ASIC, or an FPGA. Note that a combination of two or more of these integrated circuits may be used as the processor 10a. MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The graphic processing device 10b performs screen display control on an output device such as a monitor in the IO unit 10f. In addition, the graphic processing device 10b may have a configuration as an accelerator that executes machine learning process and inference process using a machine learning model. Examples of the graphic processing device 10b include various arithmetic processing devices, for example, an integrated circuit (IC) such as a graphics processing unit (GPU), an APU, a DSP, an ASIC, or an FPGA.

The memory 10c is an example of hardware that stores information such as various data and programs. Examples of the memory 10c include one or both of a volatile memory such as a dynamic random access memory (DRAM) and a nonvolatile memory such as a persistent memory (PM).

The storing unit 10d is an example of hardware that stores information such as various data and programs. Examples of the storing unit 10d include various storing devices such as a magnetic disk device such as a hard disk drive (HDD), a semiconductor drive device such as a Solid State Drive (SSD), and a nonvolatile memory. Examples of the nonvolatile memory include a flash memory, a storage class memory (SCM), and a read only memory (ROM).

The storing unit 10d may store a program 10h (relay program) for embodying all or a part of various functions of the computer 10.

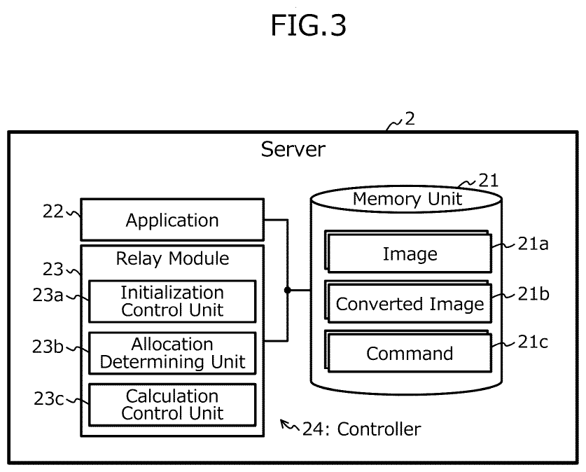

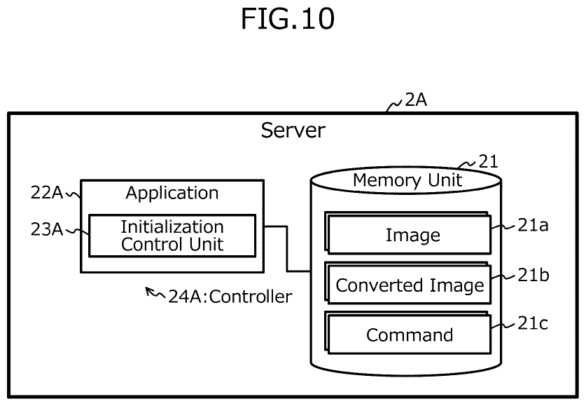

For example, the processor 10a of the server 2 may embody a function as the server 2 or 2A (for example, a controller 24 illustrated in FIG. 3 or a controller 24A illustrated in FIG. 10) to be described later by loading the program 10h stored in the storing unit 10d into the memory 10c and executing the program 10h.

The IF unit 10e is an example of a communication IF that controls connection and communication between the server 2 and the resource pool 3 or the management system 6. For example, the IF unit 10e may include an adapter that is compliant with the communication standard of the interconnect 4, such as Peripheral Component Interconnect express (PCIe), Ethernet®, InfiniBand, or Myrinet. The adapter may support one or both of wireless and wired communication methods. In addition, the adapter may be compliant with optical communication such as fibre channel (FC), for example.

For example, the server 2 may be communicably connected to each of the resource pool 3 and the management system 6 via the IF unit 10e and the interconnect 4. Note that the program 10h may be downloaded from the interconnect 4 or a network (not illustrated) to the computer 10 via the communication IF and stored in the storing unit 10d.

The IO unit 10f may include one or both of an input device and an output device. Examples of the input device include a keyboard, a mouse, and a touch panel. Examples of the output device include display devices such as a monitor, a projector, and a printer. In addition, the IO unit 10f may include a touch panel or the like in which the input device and the output device are integrated. The output device may be connected to the graphic processing device 10b.

The reader 10g is an example of a reader that reads information, such as data and programs, recorded on the recording medium 10i. The reader 10g may include a connection terminal or a device to which the recording medium 10i can be connected or inserted. Examples of the reader 10g include an adapter that is compliant with a universal serial bus (USB) or the like, a drive device that accesses a recording disk, a card reader that accesses a flash memory such as an SD card, and the like. Note that the program 10h may be stored in the recording medium 10i, and the reader 10g may read the program 10h from the recording medium 10i and store the program 10h in the storing unit 10d.

Examples of the recording medium 10i include a non-transitory computer-readable recording medium such as a magnetic/optical disk or a flash memory. Examples of the magnetic/optical disk include a flexible disk, a compact disc (CD), a digital versatile disc (DVD), a Blu-ray disc, and a holographic versatile disc (HVD). Examples of the flash memory include semiconductor memories such as a USB memory and an SD card.

The above-described hardware configuration of the computer 10 is an example. Therefore, hardware in the computer 10 may be increased or decreased (for example, addition or deletion of an optional block), divided, integrated in an optional combination, or a bus may be added or deleted as appropriate.

Returning to the description of FIG. 1, the resource pool 3 may include a pool of one or more types of hardware. For example, the resource pool 3 may include a memory pool 31 including a plurality of memories 30a, a GPU pool 32 including a plurality of GPUs 30b, and an SSD pool 33 including a plurality of SSDs 30c. Hereinafter, the memory pool 31, the GPU pool 32, and the SSD pool 33 may be referred to as a pool 30.

Each pool 30 is an example of an information processing apparatus (second information processing apparatus) or a computer on which a plurality of specific types of hardware is mounted. The specific type of hardware is hardware provided as the resource pool 3 by the pool 30. For example, a particular type of hardware is the memory 30a in the memory pool 31, the GPU 30b in the GPU pool 32, and the SSD 30c in the SSD pool 33. The specific type of hardware is not limited to the hardware illustrated in FIG. 1, and examples thereof include accelerators and various other hardware.

Each pool 30 may be, for example, a general-purpose computer on which a large number of specific types of hardware are mounted. Alternatively, each pool 30 may be a computer in which at least a part of the hardware resources constituting the computer is omitted on the premise of being used as the resource pool 3. In the embodiment, each pool 30 will be described as, for example, a computer on the premise of being used as the resource pool 3.

Each pool 30 may have a hardware configuration similar to that of the computer 10 illustrated in FIG. 2. In this case, hardware in the computer 10 of each pool 30 may be increased or decreased (for example, addition or deletion of an optional block), divided, integrated in an optional combination, or a bus may be added or deleted as appropriate. Note that the memory 30a may be similar to the memory 10c illustrated in FIG. 2, the GPU 30b may be similar to the graphic processing device 10b illustrated in FIG. 2, and the SSD 30c may be similar to the storing unit 10d illustrated in FIG. 2.

The interconnect 4 is a network (high-speed interconnect) that communicably connects the server 2, the resource pool 3, and the management system 6 in response to switching of the switch 5. The interconnect 4 may be, for example, a network corresponding to a high-speed bus architecture such as PCIe, Ethernet®, InfiniBand, or Myrinet.

The switch 5 switches (on/off) connection among the server 2, the resource pool 3, and the management system 6. For example, the switch 5 may switch the connection among the server 2, the resource pool 3, and the management system 6 in the interconnect 4 according to control from the management system 6.

The management system 6 performs overall management of the system 1, such as management of a plurality of hardware resources in the resource pool 3 and management of allocation (addition) and deallocation (deletion) of a plurality of hardware resources to the server 2. For example, the management system 6 may realize the resource allocation to the server 2 by controlling the switch 5 to cause the server 2 to detect the resource in response to receiving the resource allocation request from the server 2. For the management of the hardware resources and the management of the allocation of the hardware resources to the server 2 by the management system 6, for example, various known methods may be used.

### (B) Software Configuration Example

FIG. 3 is a block diagram illustrating an example of a software configuration of the server 2 illustrated in FIG. 1. As illustrated in FIG. 3, the server 2 may include a memory unit 21, an application 22, and a relay module 23, for example. The application 22 and the relay module 23 are examples of the controller 24.

The memory unit 21 is an example of a storage area, and stores various data used by the server 2. The memory unit 21 may be realized by, for example, a storage area included in one or both of the memory 10c and the storing unit 10d illustrated in FIG. 2.

As illustrated in FIG. 3, the memory unit 21 may store a plurality of images 21a, a plurality of converted images 21b, and a plurality of commands 21c, for example.

The application 22 is a program (application program) that executes various processes using one or both of the hardware resources of the server 2 and the hardware resources in the resource pool 3. Although not illustrated in FIG. 3, the application 22 may be executed on an operating system (OS) executed by the CPU 2a of the server 2.

In the embodiment, it is assumed that the application 22 executes an AI task using the image 21a, for example, an image analysis process. For example, the application 22 uses the GPU pool 32 of the resource pool 3 to execute training (machine learning process) of a machine learning model for performing the image analysis process. Prior to the training, the application 22 performs pre-processing of converting the image size, format, and the like of each of the plurality of images 21a to obtain the converted images 21b. Then, the application 22 transmits the converted images 21b to the GPU 30b of the GPU pool 32, and trains the machine learning model by updating the parameters of the machine learning model using the training result received from the GPU 30b.

The relay module 23 is a software module that relays various commands (requests and responses) communicated between the application 22 and the management system 6 or the resource pool 3.

For example, the relay module 23 may delay the initialization command of the hardware resource issued from the application 22 according to the resource allocation status to the application 22 by the management system 6. Details of the relay process by the relay module 23 will be described later.

The relay module 23 may be implemented in the server 2 in various ways. As an example, the relay module 23 may be implemented in the server 2 as software separate from the application 22. For example, the relay module 23 may be implemented in any one of middleware, a library, and a driver, or may be implemented across or in a distributed manner over two or more of these.

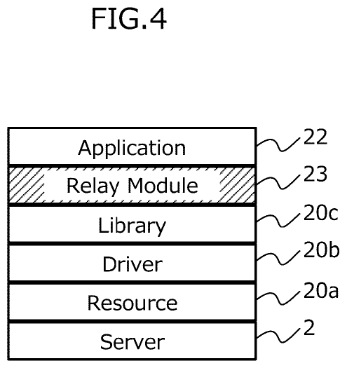

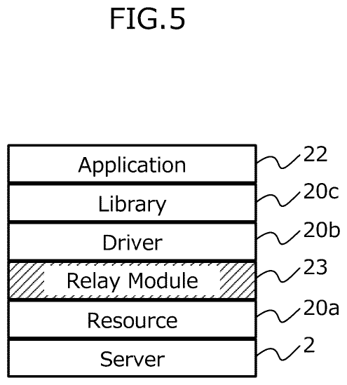

FIGS. 4 and 5 are diagrams for explaining an implementation example of the relay module 23. FIG. 4 illustrates an example in which the relay module 23 is implemented between the application 22 and a library 20c, for example, in middleware or the library 20c. FIG. 5 illustrates an example in which the relay module 23 is implemented between a driver 20b and a resource 20a, for example, in the driver 20b.

Note that the resource 20a is a hardware resource of the server 2 and may include the CPU 2a.

The driver 20b and the library 20c are modules used by the application 22 to use the resource 20a, and at least a part thereof may be implemented in the OS.

As illustrated in FIG. 4 or 5, the relay module 23 may be implemented in a lower hierarchy (layer) of the application 22. As a result, the relay module 23 can obtain various commands 21c caused by the operation of the application 22. In the example of FIG. 4, the relay module 23 receives a command 21c issued by the application 22 or the library 20c, or a command 21c addressed to the application 22 or the library 20c. Furthermore, in the example of FIG. 5, the relay module 23 receives the operation content (command 21c) for the resource 20a from the driver 20b, and performs an operation for the resource 20a instead of the driver 20b.

In this manner, the relay module 23 realizes delay in initialization of the resource pool 3 through the obtaining of the command 21c. Note that the server 2 can implement the method according to the embodiment by adding the relay module 23 while maintaining the existing software stack (in other words, an existing configuration is used for other software components of the server 2).

Returning to the description of FIG. 3, the relay module 23 may include an initialization control unit 23a, an allocation determining unit 23b, and a calculation control unit 23c, for example.

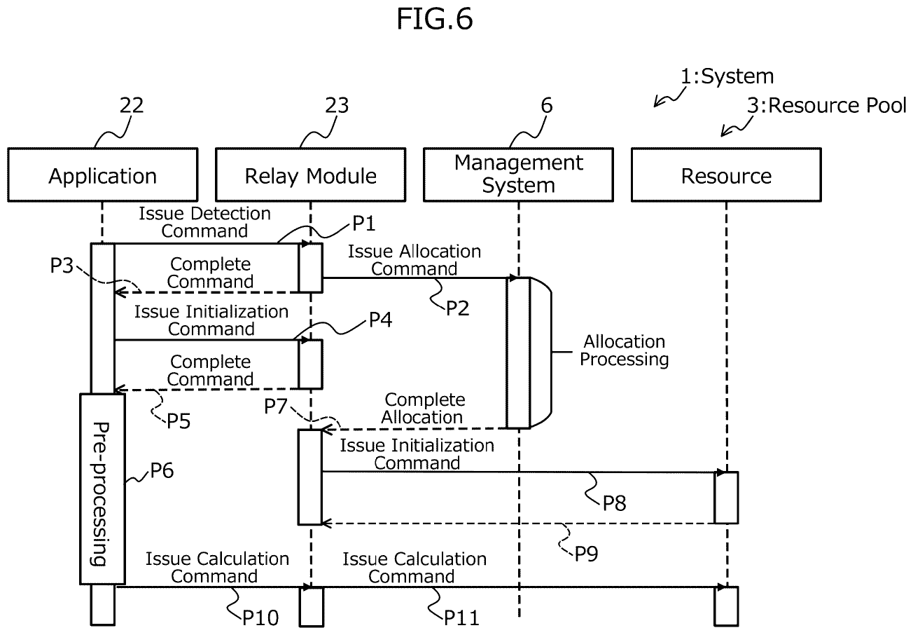

Hereinafter, an example of the process of the initialization control unit 23a, the allocation determining unit 23b, and the calculation control unit 23c will be described with reference to FIG. 6. FIG. 6 is a sequence diagram for explaining an operation example of the system 1 according to the embodiment.

The initialization control unit 23a obtains an initialization command related to initialization of resources (first resources) in the resource pool 3 from the application 22. The initialization command is an example of an initialization request for initializing a first resource being a hardware resource used by the application 22.

Note that, hereinafter, an example of relay process for one (one set) initialization command by the relay module 23 will be described using an initialization command for one resource as an example. When a plurality of (a plurality of sets of) initialization commands for a plurality of resources are issued, the relay module 23 may execute a relay process for each initialization command.

The initialization command may include, for example, a resource detection command and a resource initialization command.

The resource detection command is a command for the application 22 to detect a resource that can be detected by the application 22 (server 2). The resource detection command is issued from, for example, the application 22 or the library 20c to the management system 6. The resource detection command may include information of hardware resources to be used by the application 22, for example, information indicating types of the memory 30a, the GPU 30b, the SSD 30c, and the like. Alternatively, the resource detection command may include information indicating a specific hardware resource in the resource pool 3.

The resource initialization command is a command for initializing a resource detected by the application 22. The resource initialization command is issued from the application 22 to the resource of the resource pool 3, for example. The initialization command may include, for example, information such as an initial value to be set in the resource. As an example, the initialization command may include information such as a memory size to be secured for the GPU 30b in a case where the resource is the GPU 30b.

The application 22 issues a resource detection command in the initialization command (process P1 in FIG. 6).

Upon obtaining the resource detection command, the initialization control unit 23a transmits a resource allocation command for allocating a resource to the server 2 to the management system 6 based on the resource detection command (process P2 in FIG. 6). The resource allocation command is an example of an allocation request for allocating a resource to the server 2. Note that the initialization control unit 23a may store (record) the resource detection command (command 21c) into the memory unit 21.

When receiving the resource allocation command from the initialization control unit 23a (server 2), the management system 6 allocates a resource from the resource pool 3 to the server 2 based on the resource allocation command. As described above, the resource allocation process by the management system 6 may take about several ten seconds per resource.

When transmitting the resource allocation command to the management system 6, the initialization control unit 23a notifies the application 22 of a resource allocation completion response without waiting for a completion response from the management system 6 (process P3 in FIG. 6). For example, the initialization control unit 23a may include information of pseudo hardware resources as information of allocated resources in the completion response.

When the completion response is transmitted to the application 22, a resource initialization command is issued from the application 22 (process P4 in FIG. 6).

When obtaining the resource initialization command issued from the application 22, the initialization control unit 23a stores (records) the resource initialization command (command 21c) into the memory unit 21, and notifies the application 22 of a completion response of the resource initialization process (process P5 in FIG. 6). The resource initialization process is an example of an initialization completion response to the initialization request.

When receiving the completion response of the resource initialization process from the initialization control unit 23a, the application 22 starts a process using the resource, for example, machine learning process. For example, the application 22 executes pre-processing of the machine learning process (process P6 in FIG. 6). The pre-processing is an example of pre-processing performed before a calculation process to be executed by the first resource.

As an example, in a case where the AI task is image recognition, in the pre-processing, the application 22 reads the image 21a from the memory unit 21, converts the image into the converted image 21b, and stores the converted image 21b into the memory unit 21. For example, in the pre-processing, adjustment of colors such as brightness and saturation of the image 21a, resizing of the image 21a, normalization of parameters of pixels of the image 21a, conversion to a data format received (handled) by the machine learning model, and the like may be performed. In the resizing, enlargement, reduction, or the like for adjusting the image 21a to the size of the image received by the machine learning model may be performed. In the normalization, a conversion process for keeping the parameters of the pixels of the image 21a within 0 to 255 may be performed.

For example, in the case of the image 21a used for the machine learning process, since the pre-processing is collectively performed on the plurality of images 21a, it may take a processing time of about several ten seconds. Furthermore, in a case where the plurality of images 21a is data of a moving image, decoding process of the moving image further occurs in the pre-processing, and thus the processing time further increases.

As described above, the “pre-processing” by the application 22 has a time scale (order) similar to that of the “resource allocation process” by the management system 6.

Therefore, the initialization control unit 23a causes the application 22 to start pre-processing in response to receiving the initialization command. For example, the initialization control unit 23a according to the embodiment speculatively notifies the application 22 of a resource allocation completion response and a resource initialization process completion response in response to receiving the initialization command. Since the application 22 is designed to issue a calculation command in response to receiving these completion responses and the completion of the pre-processing, the start of the pre-processing can be realized prior to the actual resource allocation and initialization without making a change to the application 22.

As a result, the resource allocation process and the pre-processing can be executed substantially in parallel. Therefore, in a case where the processing time of the pre-processing is sufficiently long, the processing time of the resource allocation process can be offset by the processing time of the pre-processing, in other words, the processing time of the resource allocation process can be concealed. As a result, the execution time of the application 22 can be shortened.

The allocation determining unit 23b determines whether or not the resource allocation process by the management system 6 is completed.

For example, the allocation determining unit 23b may determine that the resource allocation process is incomplete when the resource detection command is stored in the memory unit 21. When receiving the allocation completion response indicating that the first resource is allocated to the server 2 as an allocation completion response to the allocation request from the management system 6 (process P7 in FIG. 6), the allocation determining unit 23b may determine that the resource allocation is completed and delete the resource detection command stored in the memory unit 21.

The initialization control unit 23a issues the resource initialization command stored in the memory unit 21 to the allocated resource in response to the determination of the completion of the resource allocation process by the allocation determining unit 23b, in other words, in response to receiving the allocation completion response (process P8 in FIG. 6). Note that the initialization control unit 23a may convert the resource initialization command stored in the memory unit 21 into a format, information, or the like suitable for initialization of the resource actually allocated to the server 2 in process P7, and then transmit the converted command to the allocated resource.

Further, when receiving a completion response indicating that the initialization in response to the resource initialization command is completed from the resource (process P9 in FIG. 6), the initialization control unit 23a may delete the resource initialization command stored in the memory unit 21.

When the pre-processing is completed, the application 22 issues a calculation command (process P10 in FIG. 6).

In response to the obtaining of the calculation command from the application 22, the calculation control unit 23c transmits the calculation command to the allocated resource (process P11 in FIG. 6). The calculation command is an example of a calculation request to be executed by the first resource, and may include, for example, the converted image 21b converted by the pre-processing.

For example, when a calculation command is issued from the application 22, the calculation control unit 23c may store (record) the calculation command (command 21c) into the memory unit 21.

When the allocation determining unit 23b determines that the resource allocation process is completed and the initialization control unit 23a receives an initialization completion response from the first resource, the calculation control unit 23c may transmit the calculation command stored in the memory unit 21 to the first resource. As a result, it is possible to reliably pass the calculation command to the first resource that is actually allocated to the server 2 and has been actually initialized.

When transmitting the calculation command to the first resource, the calculation control unit 23c may delete the calculation command from the memory unit 21.

As described above, the relay module 23 triggers the start of the resource allocation to the server 2 after the application 22 starts the resource initialization process (after issuing the initialization command), and notifies the application 22 of the completion of the initialization without waiting for the completion of the allocation. Then, the relay module 23 triggers the start of initialization of the allocated resource after completion of resource allocation. In this manner, the relay module 23 delays initialization of the resource.

As a result, the application 22 can start the process (for example, pre-processing) using resources without waiting for completion of allocation and initialization of the resources (for example, GPU). Therefore, the execution time of the application 22 can be shortened as compared with the case where the process is started after the resource allocation is completed (for example, the processes of (1) to (5) described above). In addition, depending on the length of the processing time of the pre-processing, the completion timing of the initialization of the resource and the execution timing of the calculation process using the resource can be matched (or brought close), and the processing time taken for the initialization of the resource can be concealed.

### (C) Operation Example

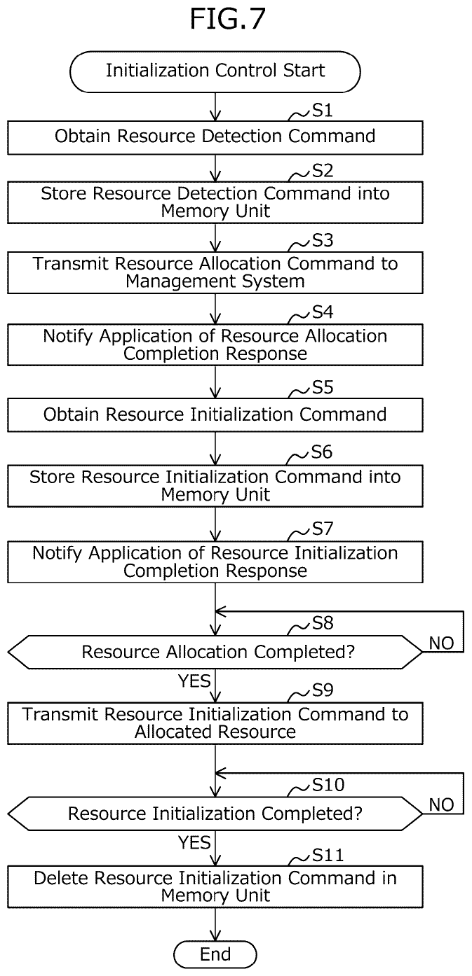

Next, an operation example of the system 1 (relay module 23) according to the embodiment will be described with reference to FIGS. 7 to 9.

### (C-1) Operation Example of Initialization Control

FIG. 7 is a flowchart illustrating an operation example of an initialization control unit 23a of the relay module 23 according to the embodiment. Note that FIG. 7 illustrates an operation example in a case where one (one set) initialization command is issued from the application 22. In a case where a plurality of (a plurality of) initialization commands is issued from the application 22, the processing illustrated in FIG. 7 may be executed for each initialization command.

As illustrated in FIG. 7, when obtaining a resource detection command in the initialization command from the application 22 (step S1), the initialization control unit 23a stores the resource detection command into the memory unit 21 (step S2).

The initialization control unit 23a issues a resource allocation command to the management system 6 based on the resource detection command (step S3).

The initialization control unit 23a notifies the application 22 of a resource allocation completion response without waiting for completion of resource allocation (step S4).

When obtaining the resource initialization command in the initialization command from the application 22 (step S5), the initialization control unit 23a stores the resource initialization command into the memory unit 21 (step S6).

The initialization control unit 23a notifies the application 22 of a resource initialization completion response without waiting for completion of resource initialization (step S7).

The initialization control unit 23a waits for completion of resource allocation (step S8, NO in step S8). When the resource allocation is completed (YES in step S8), for example, when a notification indicating completion is obtained from the allocation determining unit 23b, the initialization control unit 23a transmits the resource initialization command stored in the memory unit 21 to the resource allocated to the server 2 (step S9).

The initialization control unit 23a waits for the completion of initialization of resources (step S10, NO in step S10).

When initialization of the resource is completed (YES in step S10), for example, when the initialization control unit 23a receives an initialization completion response from the resource, the initialization control unit 23a deletes the resource initialization command stored in the memory unit 21 (step S11), and the initialization control ends.

Note that the process in step S4 illustrated in FIG. 7 may be executed at any timing between steps S1 to S5. In addition, the process of step S7 illustrated in FIG. 7 may be executed at any timing between steps S5 to S8. The process of step S7 may be executed after step S8, but in this case, the effect of shortening the execution time of the application 22 is reduced.

### (C-2) Operation Example of Allocation Determining Process

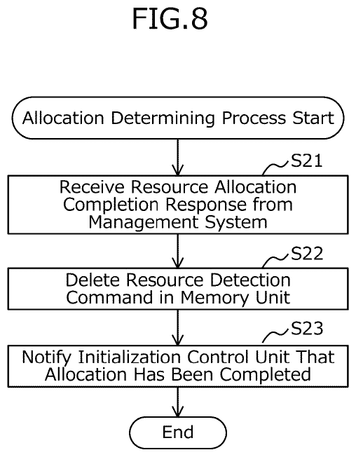

FIG. 8 is a flowchart illustrating an operation example of an allocation determining unit 23b of the relay module 23 according to the embodiment. Note that FIG. 8 illustrates an operation example in a case where the initialization control unit 23a transmits one resource allocation command to the management system 6. When the initialization control unit 23a transmits a plurality of resource allocation commands to the management system 6, the process illustrated in FIG. 8 may be executed for each resource allocation command.

As illustrated in FIG. 8, the allocation determining unit 23b receives a resource allocation completion response from the management system 6 (step S21).

The allocation determining unit 23b deletes the resource detection command stored in the memory unit 21 (step S22), notifies the initialization control unit 23a that the allocation has been completed (step S23), and ends the allocation determining process.

Note that the process in steps S22 and S23 may be performed in the reverse order or may be performed in parallel.

### (C-3) Operation Example of Calculation Control

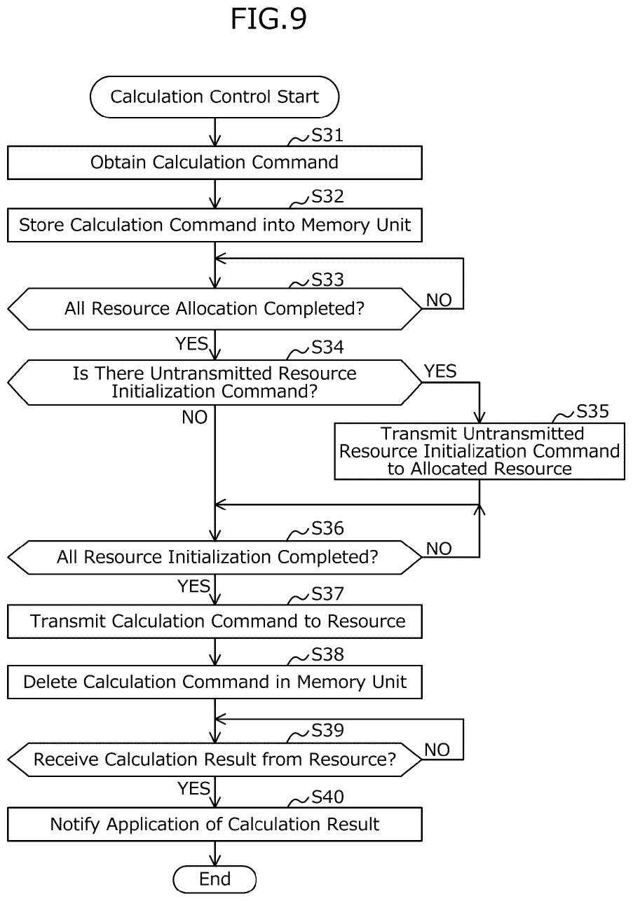

FIG. 9 is a flowchart illustrating an operation example of a calculation control unit 23c of the relay module 23 according to the embodiment. Note that FIG. 9 illustrates an operation example in a case where one or more resources are allocated to the application 22 by one (one set) or more initialization commands.

When obtaining the calculation command from the application 22 (step S31), the calculation control unit 23c stores the calculation command into the memory unit 21 (step S32).

The calculation control unit 23c determines whether or not allocation of all resources is completed (step S33). For example, the calculation control unit 23c may determine that the allocation of all the resources is completed when an allocation completion response is received from all the resources requested by the application 22 that has issued the calculation command. Alternatively, the calculation control unit 23c may determine that the allocation of all the resources is completed when the resource detection command issued from the application 22 that has issued the calculation command does not exist (does not remain) in the memory unit 21.

When the allocation of at least one resource is not completed (NO in step S33), the calculation control unit 23c waits for the completion of the allocation of all resources.

When the allocation of all the resources is completed (YES in step S33), the calculation control unit 23c determines whether or not there is an untransmitted resource initialization command (step S34).

When there is the untransmitted resource initialization command (YES in step S34), the calculation control unit 23c causes the initialization control unit 23a to transmit the untransmitted resource initialization command to the allocated resource (step S35), and the process proceeds to step S36.

When there is no untransmitted resource initialization command (NO in step S34), the calculation control unit 23c determines whether or not all resources have been initialized (step S36). For example, the calculation control unit 23c may determine that the initialization of all the resources is completed when an initialization completion response is received from all the resources requested by the application 22 that has issued the calculation command. Alternatively, the calculation control unit 23c may determine that the initialization of all the resources is completed when the resource initialization command issued from the application 22 that has issued the calculation command does not exist (does not remain) in the memory unit 21.

When the initialization of at least one resource is not completed (NO in step S36), the calculation control unit 23c waits for the completion of the initialization of all resources.

When the initialization of all the resources is completed (YES in step S36), the calculation control unit 23c transmits a calculation command to the resource allocated to the server 2 and initialized (step S37), and deletes the calculation command stored in the memory unit 21 (step S38).

The calculation control unit 23c waits for reception of the calculation result for the calculation command from the resource (step S39, NO in step S39).

When the calculation result is received from the resource (YES in step S39), the calculation control unit 23c notifies the application 22 of the calculation result (step S40), and the calculation control ends.

### (D) Modification

In the embodiment, the relay module 23 has been described as being implemented in a lower hierarchy (layer) of the application 22, but the present embodiment is not limited thereto. At least some functions of the relay module 23 may be implemented in the same hierarchy (layer) as the application 22, for example, as some functions of the application 22.

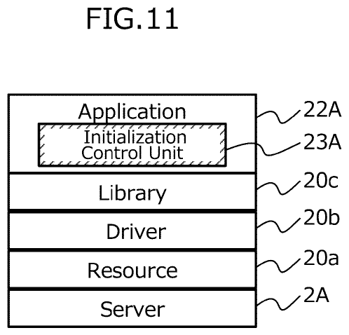

FIG. 10 is a block diagram illustrating an example of a software configuration of a server 2A according to a modification of the embodiment, and FIG. 11 is a diagram for explaining an implementation example of an initialization control unit 23A according to the modification of the embodiment. FIGS. 10 and 11 illustrate an example in which the initialization control unit 23A is mounted in the application 22.

As illustrated in FIGS. 10 and 11, the server 2A according to the modification is different from the server 2 according to the embodiment (refer to FIG. 3) in that the initialization control unit 23A is provided in an application 22A instead of the relay module 23. The initialization control unit 23A is an example of a relay module that performs a relay process. The application 22A including the initialization control unit 23A is an example of a controller 24A. Note that examples of hardware configuration of a system 1A and the server 2A may be similar to the examples of the hardware configuration of the system 1 and the server 2 illustrated in FIGS. 1 and 2.

The initialization control unit 23A may have at least some of the functions of the initialization control unit 23a and the allocation determining unit 23b (refer to FIG. 3) according to the embodiment.

When an initialization command is issued, the application 22A according to the modification starts pre-processing without waiting for reception of a completion response to the initialization command. In addition, the application 22A issues the calculation command after completion of the pre-processing and after notification of a completion response to the initialization command from the initialization control unit 23A.

When obtaining each of the initialization commands, that is, the resource detection command and the resource initialization command, the initialization control unit 23A may perform the process similar to that of the initialization control unit 23a according to the embodiment on the management system 6 and the resources.

On the other hand, the initialization control unit 23A may suppress speculative notification of the completion response to the application 22A for each of the resource detection command and the resource initialization command. This is because the application 22A includes the initialization control unit 23A to start pre-processing without waiting for notification from the initialization control unit 23A after issuing of the initialization command.

As described above, in the application 22A, the resource initialization process by the initialization control unit 23A and the pre-processing by the application 22A can be operated in parallel. Therefore, in the modification, the initialization control unit 23A can cause the application 22A to start the pre-processing while omitting the speculative notification of the completion response.

Note that the application 22A is notified of a completion response(s) indicating that resource allocation and initialization are actually completed from the initialization control unit 23A. Therefore, the calculation command issued from the application 22 after completion of the pre-processing and after obtaining the completion response may be transmitted to the resource without being relayed (delayed) by the initialization control unit 23A. In other words, in the initialization control unit 23A, the function of the calculation control unit 23c according to the embodiment may be omitted.

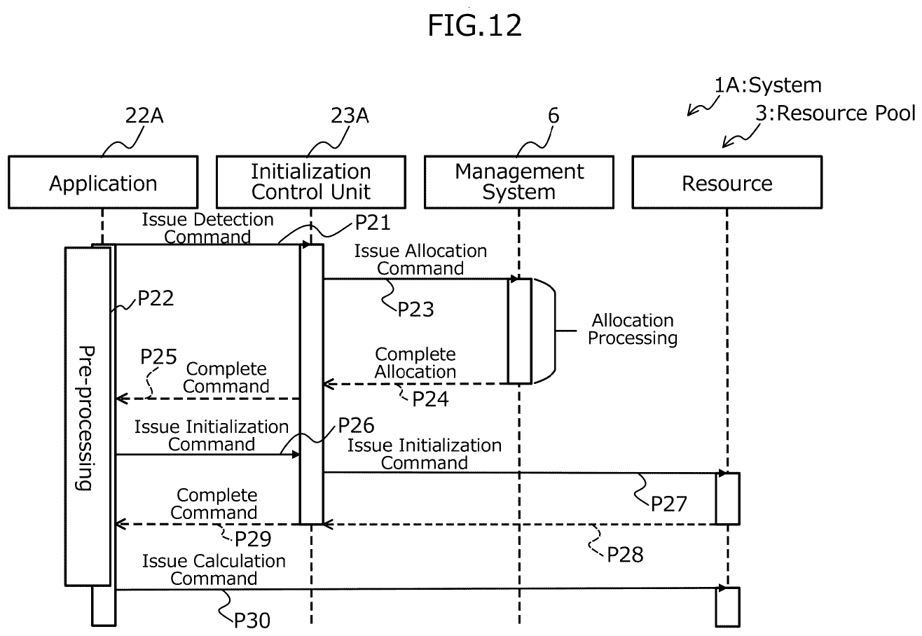

FIG. 12 is a sequence diagram for explaining an operation example of the system 1A according to the modification of the embodiment.

As illustrated in FIG. 12, the application 22A issues a resource detection command in the initialization command (process P21 in FIG. 12). In addition, the application 22A starts pre-processing after (or before) issuing the resource detection command (process P22).

Upon obtaining the resource detection command, the initialization control unit 23A transmits a resource allocation command for allocating a resource to the server 2A to the management system 6 based on the resource detection command (process P23 in FIG. 12). Note that the initialization control unit 23A may store (record) the resource detection command (command 21c) into the memory unit 21.

When receiving the resource allocation command from the initialization control unit 23A (server 2), the management system 6 allocates a resource from the resource pool 3 to the server 2A based on the resource allocation command.

The initialization control unit 23A determines whether or not the resource allocation process by the management system 6 is completed. The determining method may be similar to that of the allocation determining unit 23b according to the embodiment.

When receiving the resource allocation completion response from the management system 6 (process P24 in FIG. 12), the initialization control unit 23A determines that the resource allocation is completed. Note that the initialization control unit 23A may delete the resource detection command stored in the memory unit 21.

The initialization control unit 23A notifies the application 22A of a resource allocation completion response (process P25 in FIG. 12).

When obtaining the completion response, the application 22A issues a resource initialization command (process P26 in FIG. 12).

When obtaining the resource initialization command issued from the application 22A, the initialization control unit 23A transmits the resource initialization command to the resource (process P27 in FIG. 12). Note that the initialization control unit 23A may store (record) the resource initialization command (command 21c) into the memory unit 21.

When receiving a completion response indicating that the initialization according to the resource initialization command is completed from the resource (process P28 in FIG. 12), the initialization control unit 23A notifies the application 22A of the completion response of the resource initialization process (process P29 in FIG. 12). Note that the initialization control unit 23A may delete the resource initialization command stored in the memory unit 21.

When the pre-processing is completed and the completion response of the resource initialization process is obtained from the initialization control unit 23A, the application 22A issues a calculation command (process P30 in FIG. 12). The calculation command may include the converted image 21b converted in the pre-processing.

As described above, the system 1A according to the modification can also cause the resource allocation process and the pre-processing to be executed substantially in parallel. Therefore, in a case where the processing time of the pre-processing is sufficiently long, the processing time of the resource allocation process can be offset by the processing time of the pre-processing, in other words, the processing time of the resource allocation process can be concealed. As a result, the execution time of the application 22A can be shortened.

### (E) Others

The technology according to the above-described embodiment and modification can be modified and changed as follows.

For example, the functional blocks 23a to 23c included in the relay module 23 illustrated in FIG. 3 may be merged in an optional combination or may be divided. Furthermore, for example, the function of the initialization control unit 23A illustrated in FIG. 10 may be divided.

In addition, in the examples illustrated in FIGS. 4 and 5, an example in which the relay module 23 is mounted on the server 2 is illustrated, but the present embodiment is not limited thereto. The relay module 23 may be implemented in, for example, a computer that implements at least one pool 30 of the resource pool 3, for example, a computer (second information processing apparatus) including a first resource used by the application 22.

In the embodiment and the modification, the application 22 or 22A issues the resource detection command and the resource initialization command, but the present embodiment is not limited thereto. For example, the library 20c may issue one or both of the resource detection command and the resource initialization command.

Furthermore, in the embodiment and the modified example, the operation style in which a resource is added to the server 2 or 2A in a state where the application 22 or 22A is executed (during execution) has been described as an example, but the operation style is not limited thereto.

For example, the method according to the embodiment or the modification can also be applied to an operation style in which a resource is added to the server 2 or 2A before the application 22 or 22A is executed, and the execution of the application 22 or 22A is started after the resource is added.

In such an operation style, resource allocation to the server 2 or 2A is completed. Therefore, the relay module 23 or the initialization control unit 23A may notify the application 22 or 22A of a completion response indicating that the allocation of the first resource is actually completed in response to the resource detection command from the application 22 or 22A. The process after the notification of the completion response is similar to the process according to the embodiment or the modification.

Also in such an operation style, the application 22 can start pre-processing before receiving the completion response of the resource initialization command, and the application 22A can start pre-processing after (or before) transmitting the resource detection command. Therefore, the execution time of the application 22 or 22A can be shortened.

In one aspect, the present embodiment can shorten an execution time of an application in a case where a resource is added to an information processing apparatus that executes the application.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a relay program that causes a computer to execute a relay process comprising:
obtaining, from an application, an initialization request for initializing a first resource being a hardware resource used by the application;
transmitting, based on the initialization request, to a management system that manages a plurality of the hardware resources, an allocation request for allocating the first resource to a first computer on which the application is executed;
causing the application to start pre-processing being performed before a calculation process to be executed by the first resource;
transmitting the initialization request to the first resource in response to receiving an allocation completion response to the allocation request from the management system, the allocation completion response indicating that the first resource is allocated to the first computer from among the plurality of hardware resources; and
transmitting, in response to obtaining a calculation request of the calculation process from the application after the pre-processing is completed, the calculation request to the first resource.

2. The non-transitory computer-readable recording medium according to claim 1, wherein
the transmitting of the calculation request to the first resource comprises transmitting the calculation request to the first resource when obtaining the calculation request from the application and receiving a completion response indicating that initialization in response to the initialization request is completed from the first resource.

3. The non-transitory computer-readable recording medium according to claim 1, wherein
the computer is the first computer,
the relay program causes the first computer to execute the relay process in a layer lower than the application, and
the causing of the application to start the pre-processing comprises transmitting an initialization completion response to the initialization request to the application.

4. The non-transitory computer-readable recording medium according to claim 2, wherein
the computer is the first computer,
the relay program causes the first computer to execute the relay process in a layer lower than the application, and
the causing of the application to start the pre-processing comprises transmitting an initialization completion response to the initialization request to the application.

5. The non-transitory computer-readable recording medium according to claim 1, wherein
the computer is the first computer, and
the relay program causes the first computer to execute the relay process as a part of a function of the application.

6. The non-transitory computer-readable recording medium according to claim 2, wherein
the computer is the first computer, and
the relay program causes the first computer to execute the relay process as a part of a function of the application.

7. The non-transitory computer-readable recording medium according to claim 1, wherein
the computer is a second computer including the first resource among the plurality of hardware resources, and
the relay program causes the second computer to execute the relay process.

8. The non-transitory computer-readable recording medium according to claim 2, wherein
the computer is a second computer including the first resource among the plurality of hardware resources, and
the relay program causes the second computer to execute the relay process.

9. A relay method comprising a relay process executed by a computer, the relay process comprising:
obtaining, from an application, an initialization request for initializing a first resource being a hardware resource used by the application;
transmitting, based on the initialization request, to a management system that manages a plurality of the hardware resources, an allocation request for allocating the first resource to a first computer on which the application is executed;
causing the application to start pre-processing being performed before a calculation process to be executed by the first resource;
transmitting the initialization request to the first resource in response to receiving an allocation completion response to the allocation request from the management system, the allocation completion response indicating that the first resource is allocated to the first computer from among the plurality of hardware resources; and
transmitting, in response to obtaining a calculation request of the calculation process from the application after the pre-processing is completed, the calculation request to the first resource.

10. The relay method according to claim 9, wherein
the transmitting of the calculation request to the first resource comprises transmitting the calculation request to the first resource when obtaining the calculation request from the application and receiving a completion response indicating that initialization in response to the initialization request is completed from the first resource.

11. The relay method according to claim 9, wherein
the computer is the first computer,
the first computer executes the relay process in a layer lower than the application, and
the causing of the application to start the pre-processing comprises transmitting an initialization completion response to the initialization request to the application.

12. The relay method according to claim 10, wherein
the computer is the first computer,
the first computer executes the relay process in a layer lower than the application, and
the causing of the application to start the pre-processing comprises transmitting an initialization completion response to the initialization request to the application.

13. The relay method according to claim 9, wherein
the computer is the first computer, and
the first computer executes the relay process as a part of a function of the application.

14. The relay method according to claim 10, wherein
the computer is the first computer, and
the first computer executes the relay process as a part of a function of the application.

15. The relay method according to claim 9, wherein
the computer is a second computer including the first resource among the plurality of hardware resources, and
the second computer executes the relay process.

16. An information processing apparatus comprising:
a memory; and
a processor connected to the memory,
wherein the processor is configured to execute a relay process comprising
obtaining, from an application, an initialization request for initializing a first resource that is a hardware resource used by the application,
transmitting, based on the initialization request, to a management system that manages a plurality of the hardware resources, an allocation request for allocating the first resource to a first information processing apparatus on which the application is executed,
causing the application to start pre-processing being performed before a calculation process to be executed by the first resource,
transmitting the initialization request to the first resource in response to receiving an allocation completion response to the allocation request from the management system, the allocation completion response indicating that the first resource is allocated to the first information processing apparatus from among the plurality of hardware resources, and
transmitting, in response to obtaining a calculation request of the calculation process from the application after the pre-processing is completed, the calculation request to the first resource.

17. The information processing apparatus according to claim 16, wherein
in the transmitting of the calculation request to the first resource, the processor transmits the calculation request to the first resource when obtaining the calculation request from the application and receiving a completion response indicating that initialization in response to the initialization request is completed from the first resource.

18. The information processing apparatus according to claim 16, wherein
the information processing apparatus is the first information processing apparatus, and
the processor executes the relay process by a relay module mounted in a layer lower than the application, and transmits an initialization completion response to the initialization request to the application in the causing of the application to start the pre-processing.

19. The information processing apparatus according to claim 16, wherein
the information processing apparatus is the first information processing apparatus, and
the processor executes the relay process by a relay module implemented as a part of a function of the application.

20. The information processing apparatus according to claim 16, wherein
the information processing apparatus is a second information processing apparatus including the first resource among the plurality of hardware resources.
